(19) United States
(12) Patent Application Publication
(10) Pub. No.: US 2024/0216212 A1
(43) Pub. Date: Jul. 4, 2024

(54) PERMANENT MAGNET-PROPELLED AIR COMPRESSION MASSAGER

(71) Applicant: Shenzhen Yanai Technology Co., Ltd, Shenzhen (CN)

(72) Inventor: Yicheng Zhang, Chongqing (CN)

(73) Assignee: Shenzhen Yanai Technology Co., Ltd, Shenzhen, OT (CN)

(21) Appl. No.: 18/107,407

(22) Filed: Feb. 8, 2023

(30) Foreign Application Priority Data
Dec. 30, 2022 (CN) 202223574828.7

(51) Int. Cl. A61H 9/00; H02K 33/18

(52) U.S. Cl. CPC A61H 9/0057; H02K 33/18; A61H 2009/0064; A61H 2201/0169; A61H 2201/1215; A61H 2201/5005

(57) ABSTRACT

This utility model relates to the technical field of massage equipment, and specifically, to a permanent magnet-propelled air compression massager with a massager body. The massager body has an MCU and a peripheral control circuit, the MCU, positive and negative electrodes of the peripheral control circuit, and two ends of a coil are connected, a permanent magnet is inside the coil, a flexible leather sheath is connected to an upper end of the permanent magnet, and the flexible leather sheath wraps the permanent magnet with an lower end exposed. A solution difference between the patent and prior art is charging the coil with alternating current to generate a magnetic field for reciprocation of the permanent magnet and repeated deformation of the flexible leather sheath. The permanent magnet and coil are separated during component operation, thereby reducing friction and noise and improving service life of components and energy conversion efficiency.

### REFERENCE TO PRIOR APPLICATION

This application claims priority to Chinese Patent Application 202223574828.7, filed on 30 Dec. 2022.

### TECHNICAL FIELD

This utility model relates to the technical field of massage equipment, and specifically, to a permanent magnet-propelled air compression massager.

### BACKGROUND

As the pace of life speeds up, people likely to experience discomforts such as muscle soreness and numbness in life or work are increasing. In this case, parts of human bodies need to be massaged to relieve the discomforts by, for example, squeezing and rubbing with hands. However, during such massage, force cannot be controlled. Excessively small force cannot achieve a massage effect, and excessively great force may damage the parts of human bodies. Therefore, it is difficult to achieve a good massage effect via the traditional massage.

Auxiliary massagers in the prior art can massage the parts of human bodies, but all the existing auxiliary massagers vibrate for massaging usually a large area, instead of a small area precisely, which compromises the comfort of massage, thus resulting in a poor massage effect.

Because eccentric wheels in the conventional air compression massagers need to convert axial rotation of motor shafts into linear suction motions of flexible leather sheaths, the conventional air compression massagers have the following defects: Defect 1: Components of the air compression massagers account for a large space ratio, and therefore, cannot fully adapt to the trend of miniaturization and portability of products. Defect 2: Because it is impossible to eliminate friction completely, when the eccentric wheels, the motors, and the flexible leather sheaths drive one another, loud noise and energy loss are both caused, and as a result, it is less efficient to convert electric energy of the entire structure into suction force of the flexible leather sheaths, and service life of the components is shortened when the components are worn out due to friction.

Therefore, persons skilled in the art provide a permanent magnet-propelled air compression massager to resolve the problems mentioned in the Background.

### SUMMARY

This utility model is intended to provide a permanent magnet-propelled air compression massager to resolve the problems mentioned in the Background.

To achieve the foregoing objective, this utility model provides the following technical solutions:

A permanent magnet-propelled air compression massager is provided and includes a massager body, where the massager body is provided with an MCU and a peripheral control circuit, the MCU and a positive electrode and a negative electrode of the peripheral control circuit are respectively connected to two ends of a coil, a permanent magnet is disposed inside the coil, and a flexible leather sheath is connected to an upper end of the permanent magnet. The flexible leather sheath wraps the permanent magnet, and a lower end of the permanent magnet is unwrapped for exposure. The permanent magnet (3) is collinear with a center of the coil (2).

As a further solution of this utility model, the flexible leather sheath is made of a flexible material. The coil is formed by winding a conductive material, and maximum magnetic field intensity is adjusted by controlling a size and a shape of a winding cross-section and the number of turns of the coil. The permanent magnet is made of neodymium, rare earth metal praseodymium, pure iron, aluminum, or a boron-iron alloy material.

Compared with the prior art, this utility model has the following beneficial effects:

A difference between the solution of this patent and the prior art is that the magnetic field is generated by charging a coil with an alternating current, to propel the permanent magnet to reciprocate, to further drive the flexible leather sheath to repeatedly deform. During operation of the components, the permanent magnet does not come into direct contact with the coil, and friction and noise are significantly reduced, thereby significantly improving service life of the components and energy conversion efficiency.

### BRIEF DESCRIPTION OF DRAWINGS

FIG. 1 is a schematic structural diagram of a permanent magnet-propelled air compression massager; and

FIG. 2 is a stereoscopic diagram of a permanent magnet-propelled air compression massager.

Reference signs in the figure: 1—flexible leather sheath, 2—coil, 3—permanent magnet, and 4—MCU and peripheral control circuit.

### DESCRIPTION OF EMBODIMENTS

The technical solutions in embodiments of this utility model are clearly and completely described below with reference to the accompanying drawings in the embodiments of this utility model. Apparently, the described embodiments are only some rather than all embodiments of this utility model. All other embodiments obtained by persons of ordinary skills in the art based on the embodiments of this utility model without creative efforts shall fall within the protection scope of this utility model.

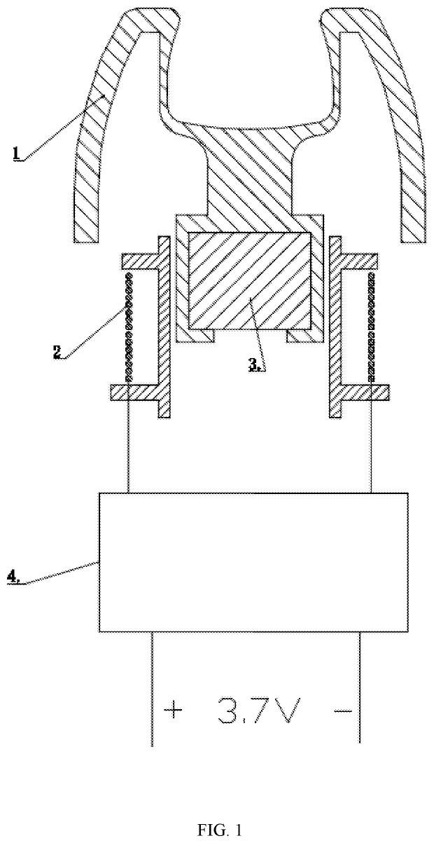

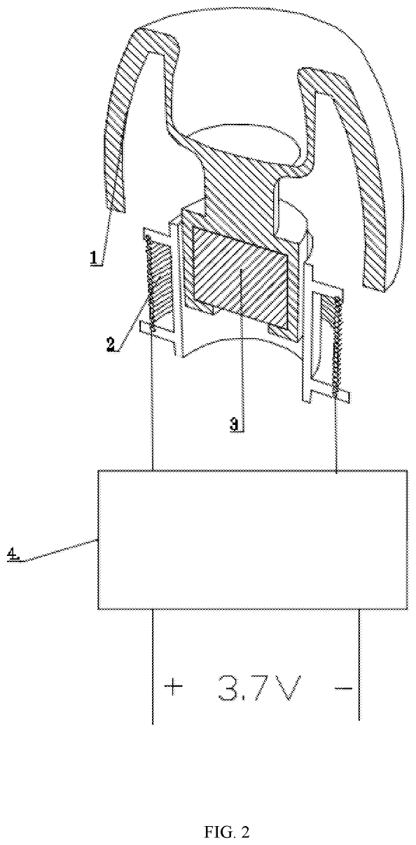

Referring to FIG. 1 and FIG. 2, in the embodiments of this utility model, a permanent magnet-propelled air compression massager is provided and includes a massager body, where the massager body is provided with an MCU and a peripheral control circuit 4, the MCU and a positive electrode and a negative electrode of the peripheral control circuit 4 are respectively connected to two ends of a coil 2, a permanent magnet 3 is disposed inside the coil 2, and a flexible leather sheath 1 is connected to an upper end of the permanent magnet 3; and the permanent magnet 3 is collinear with a center of the coil 2.

The flexible leather sheath 1 wraps the permanent magnet 3, and a lower end of the permanent magnet 3 is unwrapped for exposure.

The flexible leather sheath is made of a flexible material, where the flexible material such as flexible plastic, silica gel, and rubber may be used to produce the flexible leather sheath.

The coil is formed by winding a conductive material, and maximum magnetic field intensity may be adjusted by controlling a size and a shape of a winding cross-section and the number of turns of the coil.

The permanent magnet is made of a material such as neodymium, rare earth metal praseodymium, pure iron, aluminum, or a boron-iron alloy that has magnetism or can be magnetized under a condition.

The MCU and peripheral circuit includes a power supply, an MCU, a charging device, a pcba control device, and can charge components of the massager.

When the coil is charged with an alternating current, a magnetic field with a variable direction is generated, to push the permanent magnet 3 to reciprocate along a straight line. The permanent magnet is connected to the flexible leather sheath, and can propel the flexible leather sheath to reciprocate and deform, to repeatedly compress air to achieve a massage effect. The MCU and peripheral circuit can obtain control information input by the user to control operation of components of the air compression massager. A difference between the solution of this patent and the prior art is that the magnetic field is generated by charging a coil with an alternating current, to propel the permanent magnet to reciprocate, to further drive the flexible leather sheath to repeatedly deform. During operation of the components, the permanent magnet does not come into direct contact with the coil, and friction and noise are significantly reduced, thereby significantly improving service life of the components and energy conversion efficiency.

The foregoing descriptions are only preferable embodiments of this utility model, but the protection scope of this utility model is not limited thereto. Any equivalent replacement or variations made by persons skilled in the art based on the technical solution and concept of this utility model within the technology range disclosed in this utility model shall fall within the protection scope of this utility model.

What is claimed is:

1. A permanent magnet-propelled air compression massager, comprising a massager body, wherein the massager body is provided with an MCU and a peripheral control circuit (4), the MCU and a positive electrode and a negative electrode of the peripheral control circuit (4) are respectively connected to two ends of a coil (2), a permanent magnet (3) is disposed inside the coil (2), and a flexible leather sheath (1) is connected to an upper end of the permanent magnet (3).

2. The permanent magnet-propelled air compression massager according to claim 1, wherein the permanent magnet (3) is collinear with a center of the coil (2).

3. The permanent magnet-propelled air compression massager according to claim 1, wherein the flexible leather sheath (1) wraps the permanent magnet (3), and a lower end of the permanent magnet (3) is unwrapped for exposure.

4. The permanent magnet-propelled air compression massager according to claim 1, wherein the flexible leather sheath (1) is made of a flexible material.

5. The permanent magnet-propelled air compression massager according to claim 1, wherein the coil (2) is formed by winding a conductive material, and maximum magnetic field intensity is adjusted by controlling a size and a shape of a winding cross-section and the number of turns of the coil.

6. The permanent magnet-propelled air compression massager according to claim 1, wherein the permanent magnet (3) is made of neodymium, rare earth metal praseodymium, pure iron, aluminum, or a boron-iron alloy material.
